(19) United States
(12) Patent Application Publication
(10) Pub. No.: US 2024/0294718 A1
(43) Pub. Date: Sep. 5, 2024

(54) ULTRATHIN SHELLS FOR SCULPTING LIQUIDS

(71) Applicants: SYRACUSE UNIVERSITY, Syracuse, NY (US); ECOLE SUPERIEURE DE PHYSIQUE ET DE CHIMIE INDUSTRIELLES DE LA VILLE DE PARIS, Paris (FR)

(72) Inventors: Joseph PAULSEN, Syracuse, NY (US); Vincent DEMERY, Lyon (FR)

(21) Appl. No.: 18/573,482

(22) PCT Filed: Jun. 22, 2022
(86) PCT No.: PCT/US22/34458

§ 371 Date: Dec. 22, 2023

Related U.S. Application Data
(60) Provisional application No. 63/213,244, filed on Jun. 22, 2021.

(51) Int. Cl. C08J 5/18

(52) U.S. Cl. CPC C08J 5/18; C08J 2325/06

(57) ABSTRACT

Thin elastic films that can spontaneously attach to liquid interfaces, thereby offering a platform for tailoring their physical, chemical, and optical properties. Curved shells can be used to manipulate interfaces in qualitatively different ways. For example, an ultrathin shell with vanishing bending rigidity can impose its own rest shape on a liquid surface, in a process where the pressure across the interface inflates the shell into its original shape. The approach is amenable to optical applications as the shell is transparent, free of wrinkles, and may be manufactured over a range of curvatures.

### CROSS-REFERENCE TO RELATED APPLICATIONS

The present application claims priority to U.S. Provisional Application No. 63/213,244 filed on Jun. 22, 2021.

### STATEMENT REGARDING FEDERALLY SPONSORED RESEARCH AND DEVELOPMENT

This invention was made with government support under Grant Nos. DMR-CAREER-1654102 and No. REU DMR-1460784 awarded by the National Science Foundation. The government has certain rights in the invention.

### BACKGROUND OF THE INVENTION

### 1. Field of the Invention

The present invention relates to thin elastic films and, more specifically, to a curved polymer film that can conform to surface topographies in a liquid interface and to alter these liquid surface topographies via the geometric and material properties of the polymer film.

### 2. Description of the Related Art

Capillary forces can anchor a sufficiently thin elastic solid onto a fluid interface. Such adsorbed films offer a means to control interfaces by modifying their shape, mechanics, or permeability, or by providing a substrate for physical or chemical patterning. Crucial to such applications is an understanding of how geometric incompatibilities between a film and an interface are resolved. Current understanding in this area has been driven primarily by studies on planar sheets. Accordingly, there is a need in the art for an approach that exhibits qualitatively different behaviors from planar sheets to offer new ways to control fluid interfaces beyond what is possible with planar sheets.

### BRIEF SUMMARY OF THE INVENTION

The present invention makes use of ultrathin (100 nm) polymer films that strongly resist in-plane stretching yet readily wrinkle, allowing them to conform to a wide range of surface topographies. The invention further comprises a method to use intrinsically curved polymer films (i.e., “shells”) to control the surface topography of a liquid interface. Within a range of physical parameters described herein, the shell may impose its shape directly on the liquid (i.e., the shell may “sculpt” the liquid interface). The invention harnesses the fluid pressure from the curved liquid interface to “inflate” the shell to its intrinsic shape. The invention thus allows for improved control over the optical properties of a liquid interface.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1A is a schematic showing that adjusting the air pressure in the tube leads to different shell configurations.

FIG. 1B is a series of top-view images of a deformed shell with t=60 nm, W=2.1 mm, and R=13.8 mm, with side-view schematics. Pressure increases from left to right: i. a flat interface recovers the behavior in FIG. 2; ii. part of the wrinkled region “inflates” to its rest curvature but a wrinkled core remains; iii. the entire wrinkled region is inflated; iv. the interface curvature matches the shell curvature; v. radial wrinkles grow from the outer edge of the shell.

FIG. 1C is a graphs of the mean interfacial curvature versus r, measured from stage iii. (bottom curve) to stage iv. (top curve), for a shell with t=123 nm, W=2.2 mm, and R=13.88 mm. The center of the shell maintains a constant curvature that is close to its rest value (dashed line).

FIG. 2A is a schematic showing stretching and wrinkling on a flat liquid interface.

FIG. 2B is a graph of radial (solid line) and azimuthal (dashed line) stress in the sheet from the analytic solution.

FIG. 2C is a top-view image of an ultrathin shell (t=112 nm, W=6.6 mm, R=51.5 mm) conforming to a flat liquid interface by forming a wrinkled core of radius W′ and an unwrinkled rim. Background subtracted for clarity.

FIG. 2D is a graph of W′/W versus a for shells with 30<t<631 nm, 13.8<R<500 mm, and 2.2<W<11.4 mm on water (γ=72 mN/m, filled symbols) or an aqueous solution of sodium dodecyl sulfate (γ=36 mN/m, open symbols). Solid line: Theory with no free parameters [Eq. (5)].

FIG. 3 is a series of graphs showing numerical solution on a curved interface with α>α_{c} using R/W=6.3, γ/Y=1.7×10⁻⁴, W²pg/Y=1.1×10⁻⁴ (α=73). Panel (a) shows profiles of shells at different pressures. Dashed lines indicate wrinkled regions. The (partially) inflated regions nearly match the initial shape. Panel (b) shows curvature versus normalized radial position r/W. Dots indicate boundaries between wrinkled and smooth regions. A curvature RH=1 corresponds to the initial shape of the shell. Panel (c) shows radial stress versus normalized radial position r/W. Gray curves: Analytic solution for a flat interface (P₀=0).

FIG. 4 is a pair of graphs showing the inflated regime. Panel (a) is a phase diagram in the inextensible limit. Panel (b) is a mean curvature at the center of the shell in the “inflated” regime, for shells with a large confinement. The values are close to the intrinsic shell curvatures, R⁻¹ (dashed line), for a variety of shell curvatures and thicknesses. Repeated symbols are from the same shell at different pressures.

FIG. 5 is an image of the deformed checkerboard pattern through the interface, with the corners detected by the Harris corner detector (small circles) and the region used to compute the average curvature of the central region (gray disk).

FIG. 6 is an image of a deformed oil droplet and shell bringing part of an image below it into focus (detail from The Garden of Earthly Delights by Hieronymus Bosch). The shell has W=3.1 mm and R=7.0 mm. Scale: 2 mm.

FIG. 7 is a series of graphs showing a numerical solution for a spherical shell with R/W=20.4, γ/Y=2.3×10⁻⁴, W²pg/Y=1.8×10⁻⁴ (α=5.3) for increasing values of the pressure P₀ (yellow to black, numbers in Panel (a) indicate P₀/[pg|h(0)−h(W)|]). Panel (a) is height. Panel (b) is curvature, with the dashed line indicating the rest shape of the shell. Panel (c) is radial stress.

FIG. 8 is a graph showing the curvature at the center of the sheet as a function of pressure for low (lower line) and large (top line with triangle) confinement. The low confinement line corresponds to FIG. 7, and the large confinement line corresponds to FIG. 3. The large line starts when the center of the shell unwrinkles.

FIG. 9 is a numerical solution for a conical shell for α=0.12, R/W=0.4, γ/Y=2.3 10⁻⁴, W²pg/Y=1.8×10⁻⁴ for increasing values of the pressure P₀ (yellow to black, numbers in Panel (a) indicates P₀/[pg|h(0)−h(W)|]). Panel (a) is height, with oscillating lines indicate the wrinkled region. Panel (b) is slope, the dashed line indicates the rest shape of the shell. Panel (c) is Radial stress.

FIG. 10 is a pair of graphs of the measured gradient field (arrows) and center used for the azimuthal projection (center circle) with Right: polar projection of the gradient field as a function of the distance to the center: radial (closed symbols) and azimuthal (open symbols) components.

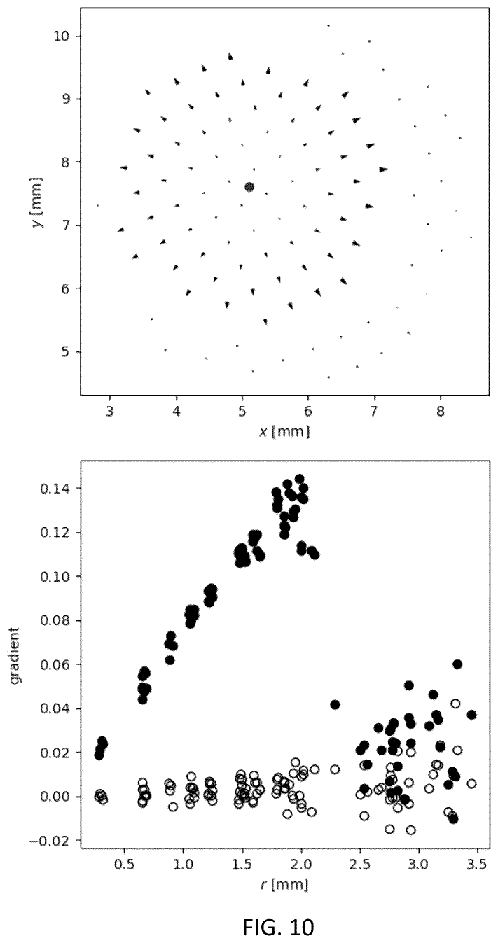

FIG. 11 is a pair of graphs of (top) mean curvature field obtained through an interpolation of the gradient field with the data is restricted to the convex hull of the detected corners, the black dot shows the center used for the azimuthal averaging, and the dashed circle shows the location of the minimum in the azimuthal average of the curvature, and (bottom) mean curvature as a function of the distance to the center (black circles) and local average (center line).

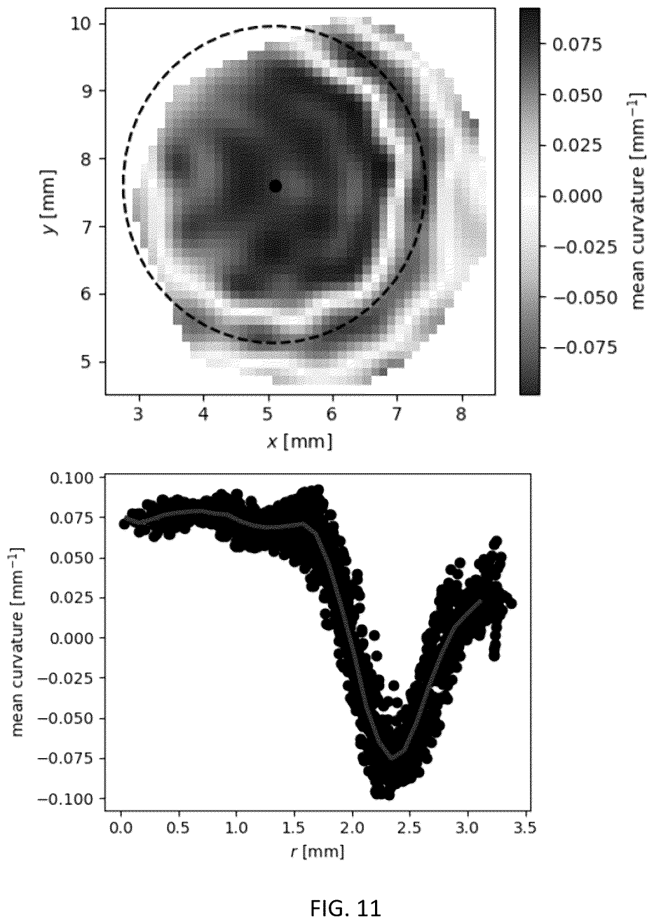

FIG. 12 is a pair of graphs of (top) radial component of the polar projection of the gradient field from the largest pressure drop (light gray) to the smallest (black) where the thick gray line shows z0=r=R, and (bottom) radial component of the gradient field for three images (dots), compared to theoretical predictions (solid lines for the shell, dashed lines for the air-water interface) with the pressures indicated by the line labels.

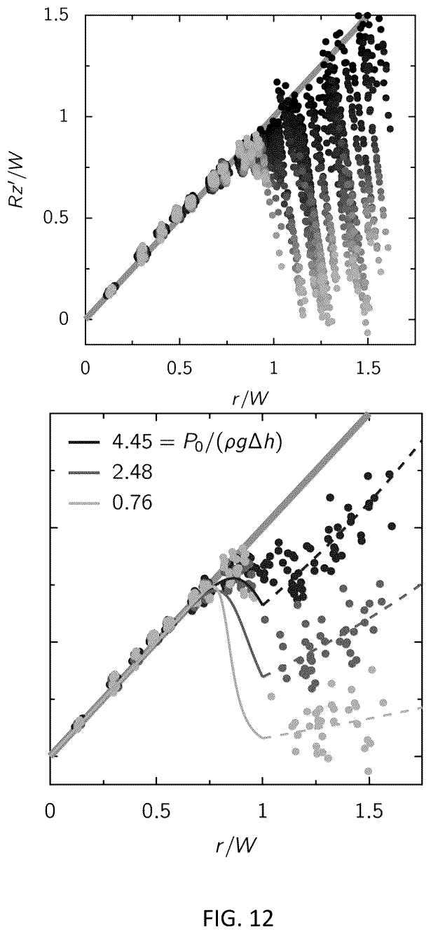

### DETAILED DESCRIPTION OF THE INVENTION

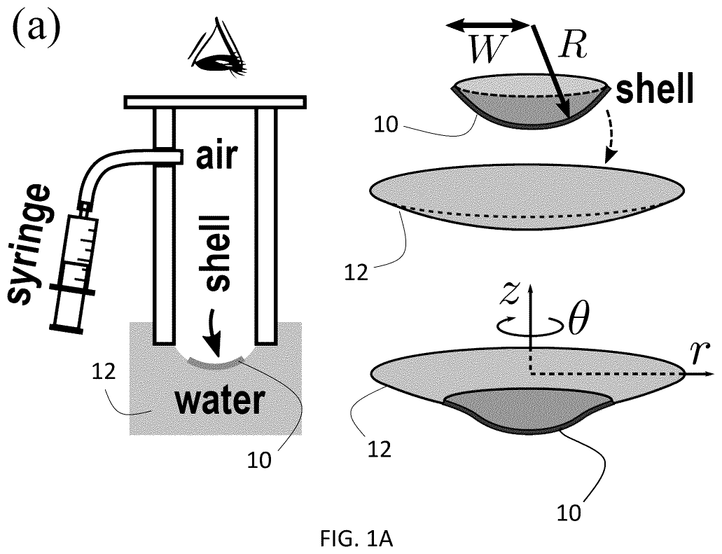

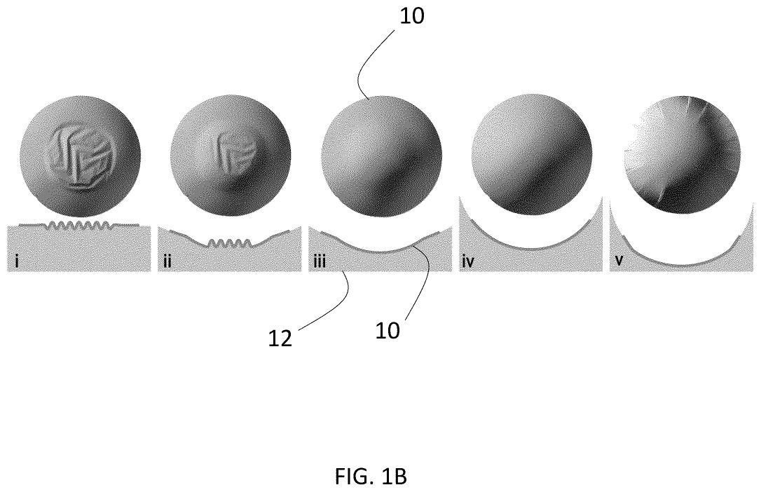

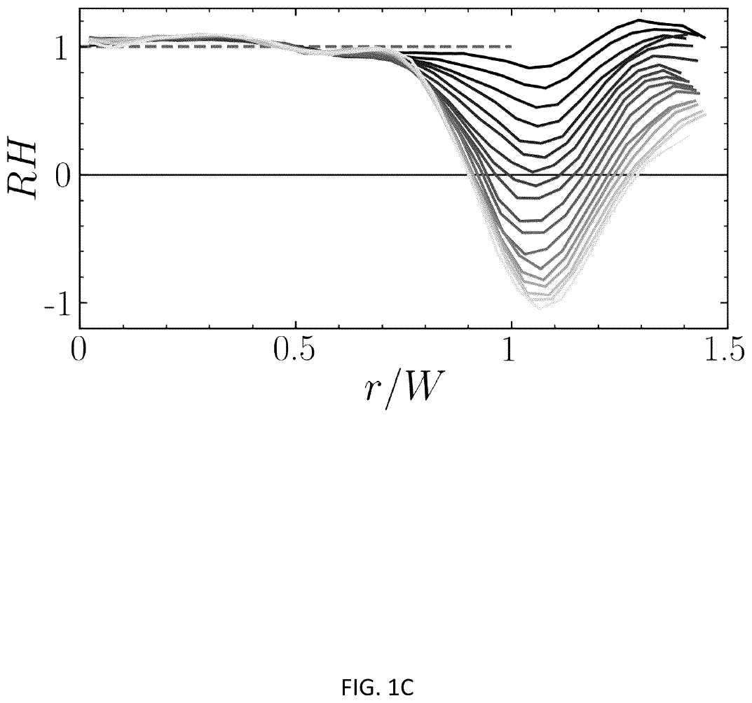

Referring to the figures, wherein like numeral refer to like parts throughout, there is seen in FIG. 1 a thin interfacial shell 10 according to the present invention that has a vanishing bending rigidity that behaves qualitatively differently than a planar film on water 12. Namely, a shell may impose its own shape on an interface over a range of pressures, offering a straightforward method to control the equilibrium shape of a fluid. One advantage of this self-inflating regime is that the deployed shape is robust to perturbations in pressure, unlike a bare liquid interface where the curvature varies continuously with the Laplace pressure. This property of the present invention can be useful for optical applications, and it may be achieved with little intervention, which we demonstrate by inflating a shell using an oil droplet floating on water.

The present invention was implemented by forming spherical polystyrene shells of Young's modulus E=3.4 GPa and thickness 119<t<154 nm by spin coating onto optical lenses with radius of curvature 7<R<26 mm. A circular domain of radius 1.8<W<3.1 mm is then cut and delivered to a flat air-water interface with surface tension γ=72 mN m, where oil or surfactant may also be added to alter the surface tension (e.g., γ=36 mN m when adding sodium dodecyl sulfate). The mechanical properties of the shell are set by its stretching and bending moduli, Y=Et and B=Et³/[12(1−v²)] respectively, and its Poisson ratio v=0.34. The parameters place us in the high bendability regime ε⁻¹=γW²/B>10³: the films buckle under minute compression. As we will show, their ability to impose their shape on a liquid is rooted in the high cost of stretching, analogous to the rigidity of a stiff mylar balloon rather than the geometric rigidity of shells that underlies the strength of architectural domes.

In experiments, the floating shell was captured with a tube as seen in FIG. TA, so that the interface curvature can be varied continuously by injecting air with a syringe. In the top-view images in FIG. 1B, it is possible to observe a central wrinkled core that shrinks as the interfacial curvature increases. Two regions with different curvatures can be identified in panels (ii) and (iii), a central core and an outer rim; the core has roughly the same size as the wrinkled region in panel (i). This distinction disappears in panel (iv), where the curvature seems uniform. In panel (v), radial wrinkles appear at the edge of the sheet, similar to those observed when a flat sheet is placed on a curved interface, suggesting that the liquid interface is more curved than the rest shape of the shell.

To quantify the interface shape throughout this process, a checkerboard pattern was viewed through the interface; tracking the optical distortion of the pattern allows one to deduce the height profile of the interface using a synthetic Schlieren technique. FIG. 1C shows the measured mean curvature H versus the distance r to the center, which has been averaged azimuthally, in a range of pressures where no wrinkles are observed [panels (iii) and (iv) in FIG. 1B]. As pressure is increased, the curvature in the center of the shell remains approximately constant and close to the intrinsic curvature of the shell. These observations herald the existence of a regime where the shell sculpts the fluid into its rest shape.

### Model

The rest shape of the shell is described by an axisymmetric height function h(r)=r²/(2R), for 0≤r≤W; the shells have small slope, W<<R. The shell is placed at the interface of a liquid with density p, and a pressure drop P₀ is imposed across the interface at the edge of the shell, setting the curvature of the interface through the Laplace law.

The stresses in the radial and azimuthal directions, σᵣᵣ and σ_{θθ}, and the height z follow the Foppl-von Karman equations, which read in polar coordinates:

$${\partial }_{r} ( r {σ}_{rr} ) = {σ}_{θθ} , \qquad ( 1 )$$

$${\partial }_{r} ( r {σ}_{θθ} ) = {σ}_{rr} + \frac{Y}{2} ( {h}^{′ 2} - {z}^{′ 2} ) , \qquad ( 2 )$$

$${z}^{″} {σ}_{rr} + \frac{{z}^{′}}{r} {σ}_{θθ} = {P}_{0} + ρ gz , \qquad ( 3 )$$

where g is the gravitational acceleration. The first equation is the in-plane force balance in the radial direction. The second equation is a compatibility condition, which highlights the role of the mismatch between the rest shape and the actual shape of the sheet as a source of stress. The third equation is the vertical force balance, where the bending contribution has been discarded. These equations must be supplemented with boundary conditions, provided at r=0 by the smoothness of the shape, z′(0)=0, the continuity of displacement, σᵣᵣ(0)=σ_{θθ}(0); and at r=W by the radial force balance, σᵣᵣ(W)=γ, and the convention z(W)=0.

Tension field theory is used to predict the shape of the shells: the stress field in any direction is imposed as positive or zero. A vanishing stress means that compression is released by small scale features such as wrinkles; such features are not described and instead the gross shape of the sheet is described through the height function z(r).

### Flat Interface

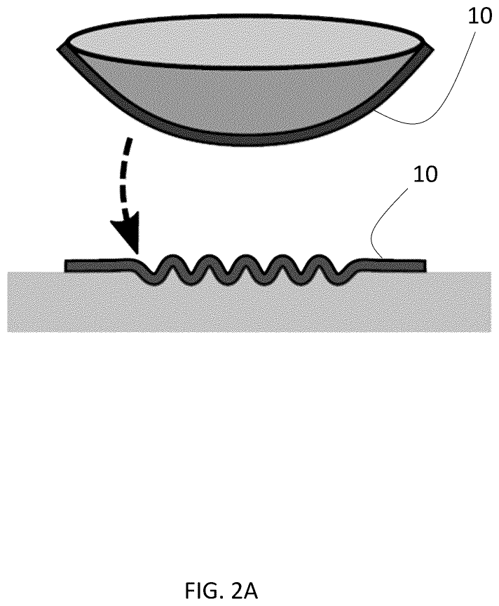

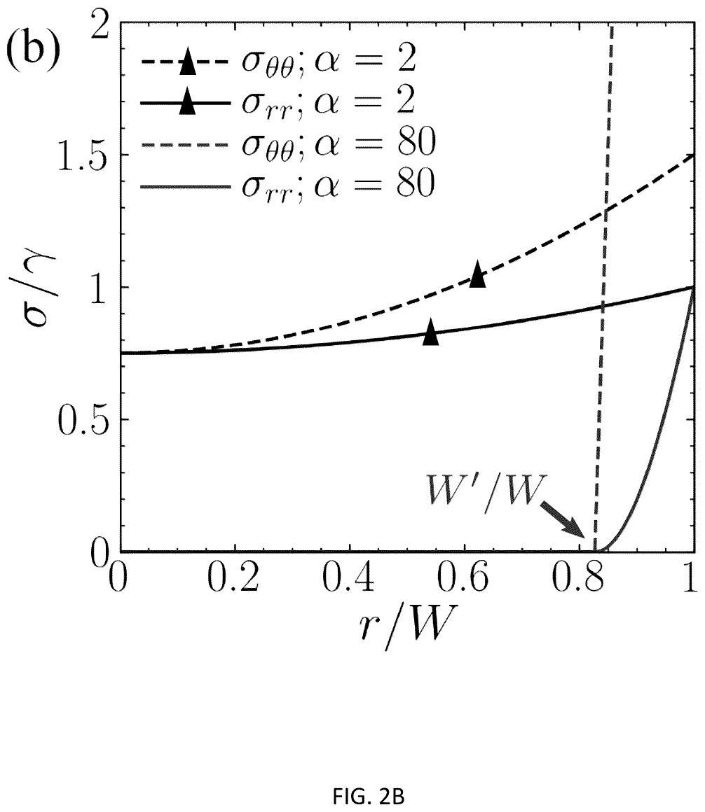

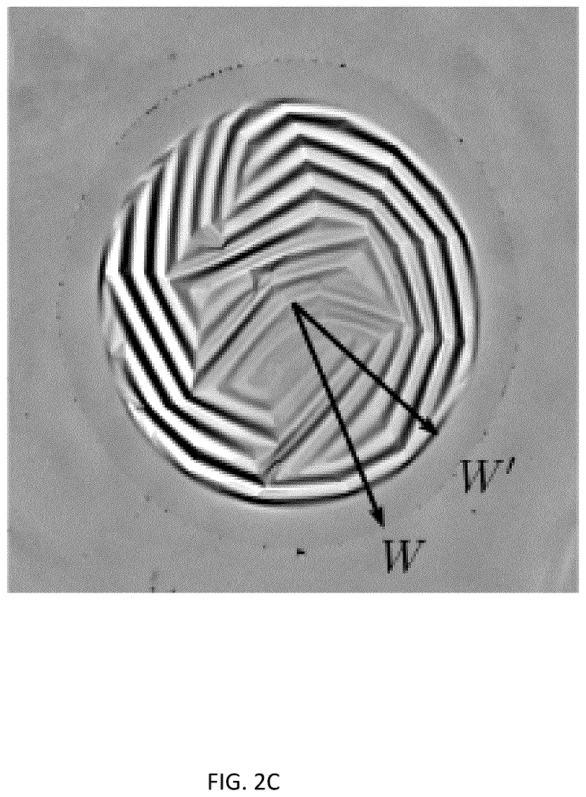

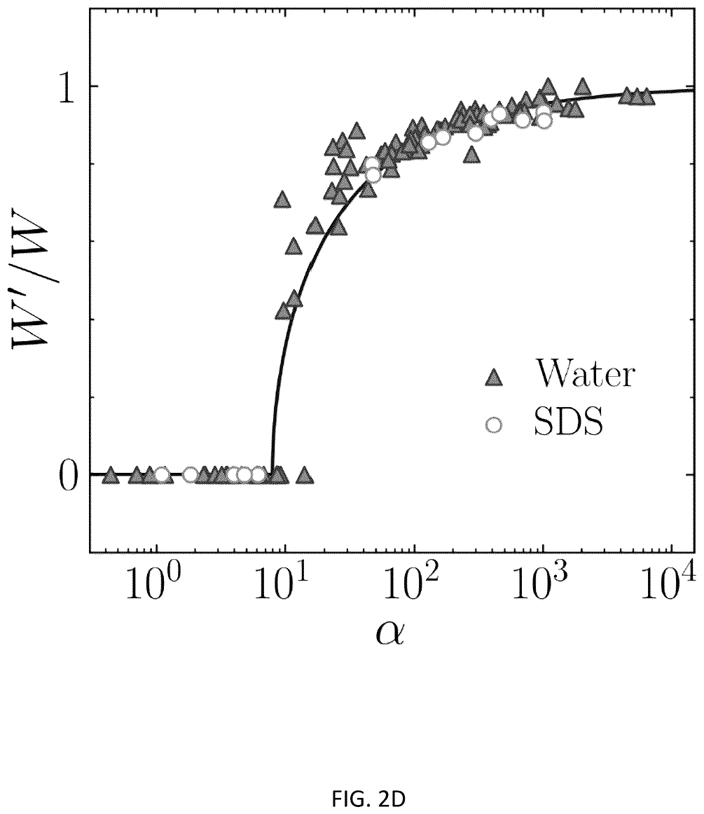

The situation where no pressure drop is imposed across the interface, P₀=0 FIG. 2A is considered first. In this case, the sheet remains flat, as z=0 solves the vertical force balance [Eq. (3)]. Then, the solution to Eqs. (1, 2) depends only on the dimensionless confinement parameter

$$α = \frac{{YW}^{2}}{2 γ {R}^{2}} , \qquad ( 4 )$$

which compares the tension applied at the edge, γ, to the stress that is required to flatten the shell, YW²/R². There is a critical value of the confinement, α_{c}=8, below which the stresses remain positive over the whole sheet [FIG. 2B, black lines].

On the contrary, above the critical value, the solution should vanish in a circular region around the center of the sheet, indicating the appearance of small-scale features [FIG. 2C]. Inspection of Eqs. (1, 2) shows that the stress vanishes in the same region in the two directions: σᵣᵣ=0 and σ_{θθ}=0 for r<W′, so that the boundary condition at r=0 has to be replaced by the condition σᵣᵣ(W′)=0. Solving the force balance equations with the new boundary condition for W′<r<W provides the stress field in the sheet [FIG. 2(b), gray lines], and the value of W′:

$$\frac{{W}^{′}}{W} = \sqrt{1 - \sqrt{\frac{{α}_{e}}{α}}} . \qquad ( 5 )$$

A wrinkled region is thus predicted in the center of the shell whenever α≥α_{c}, having a size W′ that grows continuously with a, reaching W′=Win the limit α→∞[FIG. 2D, solid line]. The sheet remains unwrinkled in a rim of width L=W-W′, which becomes independent of the radius of the sheet at large confinement:

$$L \sim W \sqrt{\frac{2}{α}} = 2 R \sqrt{\frac{γ}{Y}} . \qquad ( 6 )$$

Experiments on a flat bath support these predictions. FIG. 2C shows the central region of disordered wrinkles, surrounded by an unwrinkled rim. The size of the wrinkled region W′ is plotted as a function of the confinement α in FIG. 2D. The data fall onto Eq. (5) over 4 orders of magnitude in a with no free parameters. Good agreement is also found at a second value of surface tension [open symbols in FIG. 2C].

### Curved Interface

The situation where a pressure drop is imposed across the interface is considered next. Once again there are solutions to Eqs. (1-3) with a wrinkled core or without one. If there is a wrinkled core with radius W′, then the hydrostatic pressure vanishes there: z(r)=P₀ (pg) for 0≤r≤W′, consistent with the vertical force balance (3) in the absence of stress. This sets the boundary condition at r=W′. In the unwrinkled portion, Eqs. (1-3) are integrated numerically using the boundary value problem solver integrate.solve_bvp implemented in SciPy.

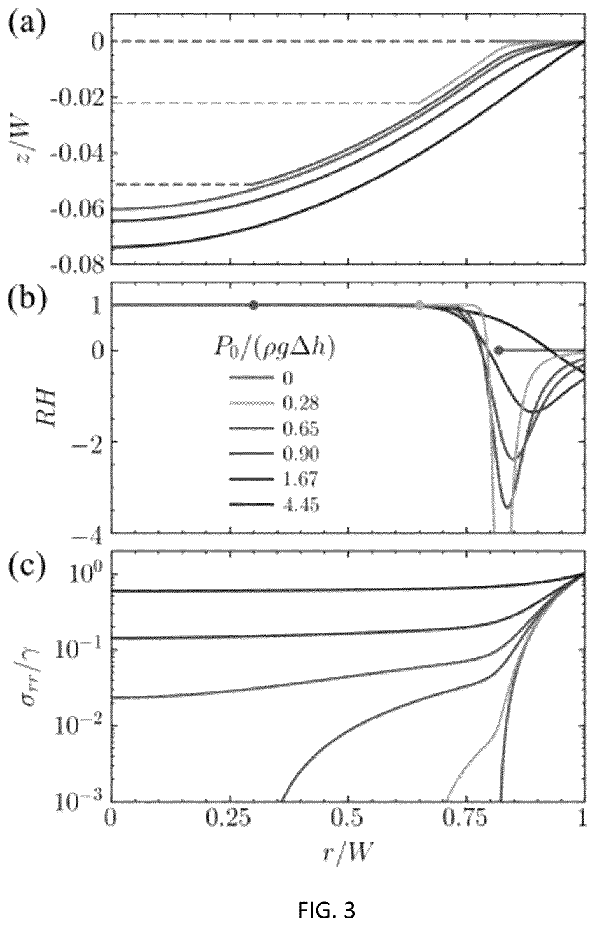

FIG. 3 shows the numerical results corresponding to the sheet in FIG. 1C, which has a confinement α=73>>α_{c}, the profile of the sheet z(r), its mean curvature H(r)=[z″(r)+z′(r)/r]/2 and the radial stress field σᵣᵣ(r) for different values of the pressure P₀ is plotted. The top curve of FIG. 3, panel (a) shows that at zero pressure, there is a wrinkled zone in the center and an unwrinkled rim at the edge; this is simply the flat interface case of FIG. 2. For small positive pressure, the wrinkled region “inflates” to the height z*=−P₀/(pg) with wrinkles persisting in the center where z=z*. As in the flat case, the radial stress falls to 0 at the edge of the wrinkled region [FIG. 3, panel (c)]. Remarkably, between the wrinkled region and the outer rim, the profile of the sheet is very close to its shape at rest: RH≈1 [FIG. 3, panel (b)]. If the pressure is large enough, the sheet deploys completely: the wrinkles in the center are gone and the sheet is under tension everywhere. The size of this “inflatable” region is close to that of the wrinkled region when the same shell is on a flat bath, so that the size of the rim on a curved interface is also given by Eq. (6). This phenomenology matches the experimental observations (FIG. 1). The behavior is very different at small confinement, where there would be no wrinkles on a flat interface: in this case the shell departs significantly from its rest shape on a curved interface. A key quantity is the minimum pressure P_{c} needed to inflate the shell completely. It can be estimated as P_{grav}=pgΔh, where Δh=W²/(2R) is the initial height of the shell. For the parameters in FIG. 3, we find P_{grav}≈0.20 P_{Lap}, where P_{Lap}=2γ/R is the Laplace pressure required to create a liquid interface of the same curvature. This estimate is an upper bound due to the flattened rim; the pressure needed to inflate the sheet in our numerical solution is 0.16 P_{Lap}.

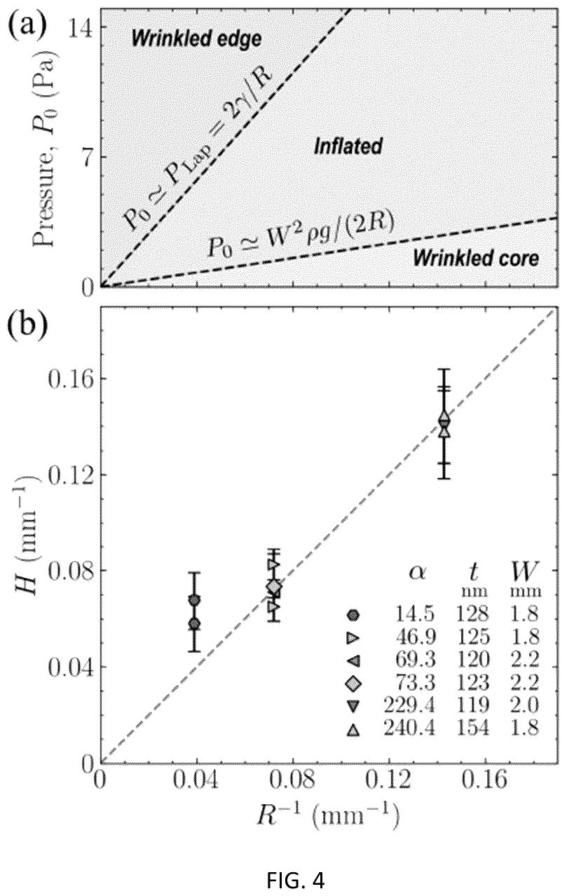

In the inextensible limit Y→∞, the rim disappears and the sheet is perfectly inflated for P_{grav}<P<P_{Lap}. This range of pressures is shown in FIG. 4(a) as a function of the curvature of the shell; there is a wrinkled core for P<P_{grav} and a wrinkled edge for P>P_{Lap}. For a finite stretching modulus, the range of the “inflated region” increases while the size of the inflated core shrinks [Eq. (5)]. Experiments with a flat sheet by others correspond to the vertical axis of FIG. 4, panel (a) at zero curvature; there only the “wrinkled edge” region is accessible. This theoretical picture is validated by entering the inflated regime in 5 additional experiments spanning a range of curvatures and thickness, all at large confinement. Each shell inflates to its original shape: the measured curvature in the center of the shell is in agreement with the intrinsic shell curvature [FIG. 4, panel (b)].

### Discussion

The experiments above demonstrate that a thin interfacial shell with vanishing bending rigidity behaves qualitatively differently than a planar film. Namely, a shell may impose its own shape on an interface over a range of pressures, offering a straightforward method to control the equilibrium shape of a fluid. One advantage of this self-inflating regime is that the deployed shape is robust to perturbations in pressure, unlike a bare liquid interface where the curvature varies continuously with the Laplace pressure. This property should be useful for optical applications, and it may be achieved with little intervention, which is demonstrated by inflating a shell using an oil droplet floating on water.

Although the discussion focused on spheres, the analysis can be generalized to any axisymmetric shell. When the stretched rim is narrow, its size should depend only on the slope of the shell at the edge, h′(W), since this is the sole aspect of the shape that appears explicitly in the force balance [Eqs. (1-3)]. Writing Eq. (6) using the slope h′(W)=W/R, we find L≃2W\sqrt{γ/Y}/h′(W). This generalization is supported by a detailed analysis of a conical shell on a curved interface. Moreover, the numerical results for a cone show that the region that is wrinkled for P₀=0 corresponds to the region that inflates to its rest shape at sufficient pressure, just as it does for a spherical shell.

Not all axisymmetric shells will inflate to their rest shape when a pressure drop is applied across the interface. The question of which shapes are maintained upon inflation dates back to the optimization of parachutes. Since then, closed surfaces have received the most attention. Recently, others have reported a condition for an axisymmetric shell to retain its shape upon inflation, although these calculations are for a uniform pressure drop across the shell; the condition in the presence of a pressure gradient is as yet unknown. Whatever this condition may be, the present invention suggests that it is satisfied for a sphere and a cone.

### EXAMPLE

### Film Preparation

Spherical shells are formed by spin coating dilute solutions of polystyrene (Mₙ=99 k, M_{w}=105.5 k, Polymer Source) in toluene (99.9%, Fisher Scientific) on optical lenses. Film thickness is varied by changing the polymer concentration and spinning speed. Some of the glass substrates were prepared with a thin layer of poly(acrylic acid); this aids in releasing the shells from the substrates as this sacrificial layer dissolves in water. Experiments with and without this sacrificial layer gave consistent results. Following the experiments, the shell thickness is measured using a white-light interferometer (Filmetrics F3).

### Interface Shape Analysis

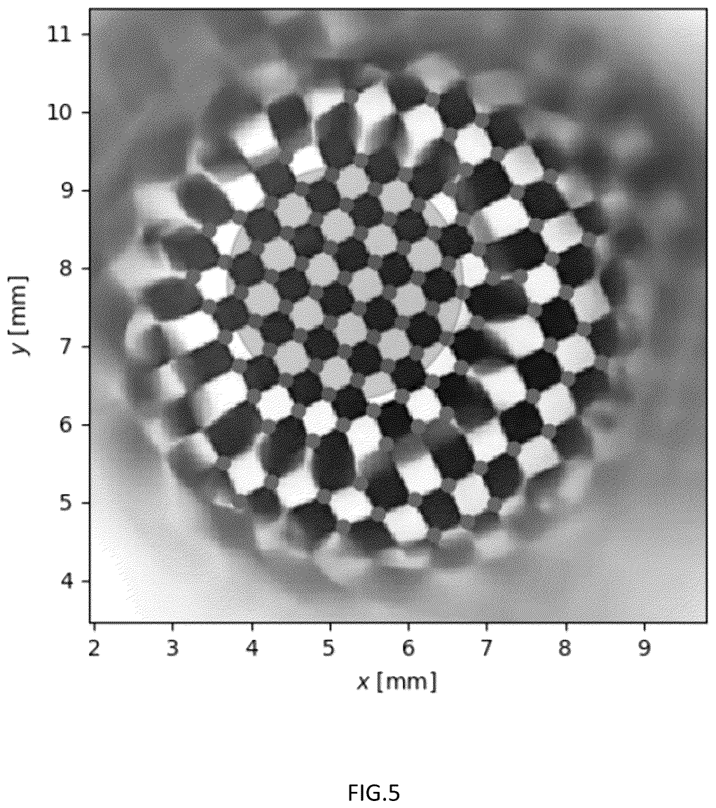

To determine the shape of the interface, we use a method inspired from the synthetic Schlieren technique. In the experiment, a checkerboard pattern was viewed through the interface, made up of squares that are 0.5 mm wide. The corners of the pattern are then detected using a Harris corner detector (FIG. 5). Identifying the corners with the points of the original square lattice, which can be done by eye or automatically, it is possible to deduce the displacement (5r, of the corners due to the deviation from a planar interface. Note that this method does not require an image of the pattern through a planar interface, which is not readily acquired, since the checkerboard is obscured by wrinkles in the shell, and the wrinkled patch is at its maximal size when the liquid interface is flat (P₀=0). The slope of the interface h is related to the displacement δr through δr=δr(βhₚ) in the limit of small slopes, where β≈0.24 for a water-air interface and hₚ is the pattern-interface distance. This relation gives us the slope of the interface at the position where each corner is detected.

The gradient field can be interpolated and differentiated to obtain the curvature field. As one is looking for an axisymmetric shape, the best azimuthal averaging of the curvature field (optimizing over the position of the center) is searched. The curvature as a function of distance to the center given in FIG. 1C. Alternatively, the gradient field can be fit to a constant curvature gradient over some region around the center of the shell (FIG. 5), leading to the average curvature of the central inflated region of the shell in FIG. 4, panel (b). Here, the main source of error is in the scale of the image; the error bars in FIG. 4, panel (b) have been obtained by assuming an error of 0.5 pixels for the size of the squares in a reference image. Note that because the checkerboard has a finite resolution of 0.5 mm, the data may be broadened by a similar magnitude. This would not affect the measurements near the center of the shell where the curvature is found to be approximately constant.

### Optical Clarity of Inflated Ultrathin Shells

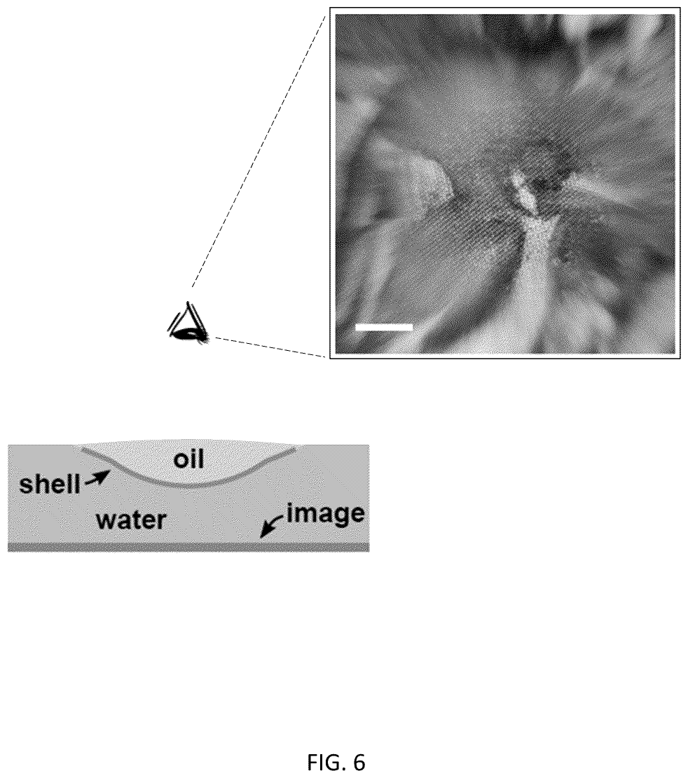

The experiments discussed above were performed on an air-water interface. The inflation of a shell on an oil-water interface, without the aid of a tube to pin the meniscus, was tested next. A polystyrene shell was delivered to a flat water bath and a 25 μL oil droplet was deposited onto it (fluorinated oil with p=1,860 kg/m³, γ=16 mN/m). The oil droplet inflates the shell and removes all wrinkles. To demonstrate the optical clarity of the system, a camera was focused on an image at the bottom of the water bath, looking through the sculpted oil droplet. FIG. 6 shows the high clarity of the result: the halftone dots of the printed image may be seen clearly under the shell.

### Equations

The equations for an axisymmetric configuration of the sheet were derived using tension-field theory. The most general equations that include pressure across the interface, gravity, and out-of-plane deformation of the sheet were derived directly first. They are then adapted to the particular case of a flat interface.

### Bulk Equations

The first equation for the radial and orthoradial components of the stress field, σᵣᵣ and σ_{θθ} respectively, is the in-plane force balance,

$${\partial }_{r} ( r {σ}_{rr} ) = {σ}_{θθ} . \qquad ( S 1 )$$

The second equation is a compatibility condition. Denoting the radial displacement u(r), the strain in the radial and orthoradial directions is

$${ϵ}_{rr} = {u}^{′} + \frac{{𝓏}^{′2}}{2} - \frac{{h}^{′2}}{2} , \qquad ( S2 )$$

$${ϵ}_{θθ} = \frac{u}{r} . \qquad ( S3 )$$

One can thus write

$${u}^{′} = {\partial }_{r} ( r {ϵ}_{θθ} ) = {ϵ}_{rr} + \frac{{h}^{′2} - {𝓏}^{′2}}{2} . \qquad ( S4 )$$

The strain is related to the stress via Hooke's law

$${ϵ}_{rr} = \frac{{σ}_{rr} - v {σ}_{θθ}}{Y} , \qquad ( S5 )$$

$${ϵ}_{θθ} = \frac{{σ}_{θθ} - v {σ}_{rr}}{Y} . \qquad ( S6 )$$

Injecting these relations in Eq. (S4) and using the in-plane force balance Eq. (S1), we obtain

$${\partial }_{r} ( r {σ}_{θθ} ) = {σ}_{rr} + \frac{Y}{2} ( {h}^{′2} - {𝓏}^{′2} ) . \qquad ( S7 )$$

The out-of-plane force balance reads

$${z}^{″} {σ}_{rr} + \frac{{𝓏}^{′}}{r} {σ}_{θθ} + {P}_{0} - ρ g 𝓏 = 0. \qquad ( S8 )$$

Finally, note that Eqs. (S1, S7, S8) are valid when the stresses are positive. When the stresses are zero, they reduce to

$${P}_{0} = ρ g 𝓏 . \qquad ( S9 )$$

With this approach, it is possible to coarse-grain over the individual wrinkles that may appear in the film and solve for the gross shape of the film.

### Boundary Conditions

The first boundary condition is given by the surface tension:

$${σ}_{rr} ( W ) = γ . \qquad ( S10 )$$

If the stresses are positive everywhere, the second boundary condition is that the stresses should be equal at the center of the sheet:

$${σ}_{rr} ( 0 ) = {σ}_{θθ} ( 0 ) . \qquad ( S11 )$$

If the stresses vanish on some interval 0≤r≤W′, the force balance (S1) implies that they should vanish on the same interval, and the boundary condition is

$${σ}_{rr} ( {W}^{′} ) = {σ}_{θθ} ( {W}^{′} ) = 0. \qquad ( S12 )$$

Note that this is equivalent to sᵣᵣ(W′)=s_{θθ}(W′)=0. There are also boundary conditions for the height, which are

$$𝓏 ( {W}^{′} ) = 0 , \qquad ( S13 )$$

which can be seen as convention. The other condition depends on the situation: if there is no wrinkled region at the center, we can take

$${𝓏}^{′} ( 0 ) = ( 0 ) . \qquad ( S14 )$$

If there is a wrinkled region, it should be

$$𝓏 ( {W}^{′} ) = \frac{{P}_{0}}{ρ g} . \qquad ( S15 )$$

Asymptotic behavior as r→W′⁺

If there is a wrinkled region over [0, W], where σᵣᵣ=σ_{θθ}=0 and

$$𝓏 = \frac{{P}_{0}}{ρ g} ,$$

we can compute the behavior of the stresses and height as r [symbol] W^{′+} from Eqs. (S1, S7, S8); this is useful for obtaining the numerical solution. It is then possible to assume the asymptotic behavior

$${σ}_{rr} ( r ) \sim {A ( r - {W}^{′} )}^{μ} , \qquad ( S16 )$$

$${σ}_{θθ} ( r ) \sim {B ( r - {W}^{′} )}^{v} , \qquad ( S17 )$$

$${𝓏}^{′} ( r ) \to {𝓏}^{′} . \qquad ( S18 )$$

From Eq. (S1), one gets μ=v+1 and μA=B/W′. From Eq. (S7), assuming that the right hand side does not vanish, to have v=1 and

$${BW}^{′} = \frac{Y}{2} ( {h}^{′2} - {𝓏}^{′2} ) .$$

Finally, from Eq. (S8), assuming that z″(r) remains bounded, we obtain

$$\frac{{z}^{′} B}{{W}^{′}} = ρ g {z}^{′} ,$$

hence B=pgW′. Inserting in the previous expression of B, we get

$${z}^{′2} = {h}^{′2} - \frac{2 W \text{?} ρ g}{Y} .$$

$$\text{?} \text{indicates text missing or illegible when filed}$$

Thus, it is determined that

$${σ}_{rr} ( r ) \sim \frac{ρ g}{2} {( r - {W}^{′} )}^{2} , \qquad ( S19 )$$

$${σ}_{θθ} ( r ) \sim ρ g {W}^{′} ( r - {W}^{′} ) , \qquad ( S20 )$$

$${z}^{′} ( {W}^{′} ) = - \sqrt{{{h}^{′} ( {W}^{′} )}^{2} - \frac{2 {W}^{′2} ρ g}{Y}} . \qquad ( S21 )$$

### Solution for a Spherical Shell on a Planar Interface

### General Equations

A spherical shell with radius R, that is, h(r)=r²/(2R) is considered. Assuming that the interface and the sheet are planar: P₀=0 and z=0. The stress field is described by Eqs. (S1, S7):

$${\partial }_{r} ( r {σ}_{rr} ) = {σ}_{θθ} , \qquad ( S22 )$$

$${\partial }_{r} ( r {σ}_{θθ} ) = {σ}_{rr} + \frac{{Yr}^{2}}{2 {R}^{2}} . \qquad ( S23 )$$

We look for a solution of the form

$${σ}_{rr} ( r ) = {Ar}^{2} + B + \frac{C}{{r}^{2}} , \qquad ( S24 )$$

$${σ}_{θθ} ( r ) = {A}^{′} {r}^{2} + {B}^{′} + \frac{{C}^{′}}{{r}^{2}} . \qquad ( S25 )$$

Eq. (S22) imposes A′=3A, B′=B and C′=−C, and Eq. (S23) sets A=Y/(16R²). The boundary condition at the edge of the sheet, Eq. (S11), leads to A W²+B+CW⁻²=γ.

$${σ}_{rr} ( r ) = \frac{Y ( {r}^{2} - {W}^{2} )}{16 {R}^{2}} + γ , \qquad ( S26 )$$

$${σ}_{θθ} ( r ) = \frac{Y ( 3 {r}^{2} - {W}^{2} )}{16 {R}^{2}} + γ . \qquad ( S27 )$$

The stresses are positive if

$$\frac{{YW}^{2}}{16 {R}^{2}} < γ .$$

The relevance of the confinement parameter are recognized:

$$α = \frac{{YW}^{2}}{2 {γR}^{2}} . \qquad ( S28 )$$

The stresses are positive everywhere provided

$$α \leq {α}_{c} = 8. \qquad ( S29 )$$

For the case where α>α_{c}, the boundary condition (S12), σᵣᵣ(W′)=σ_{θθ}(W′)=0 should be used. It leads to B=−Y W′²/(8R²) and C=Y W′⁴/(16R²), with

$${W}^{′} = \sqrt{1 - \sqrt{\frac{{α}_{c}}{α} .}} \qquad ( S30 )$$

### Solution for a Conical Shell on a Planar Interface

Considering a conical shell with slope a: h(r)=ar, the stress field obeys Eqs. (S1, S7):

$${\partial }_{r} ( r {σ}_{rr} ) = {σ}_{θθ} , \qquad ( S31 )$$

$${\partial }_{r} ( r {σ}_{θθ} ) = {σ}_{rr} + \frac{{Ya}^{2}}{2} . \qquad ( S32 )$$

The stress field is thus of the form

$${σ}_{rr} ( r ) = A - \frac{B}{{r}^{2}} + \frac{{Ya}^{2}}{4} log ( r ) , \qquad ( S33 )$$

$${σ}_{θθ} ( r ) = A - \frac{B}{{r}^{2}} + \frac{{Ya}^{2}}{4} [ log ( r ) + 1 ] . \qquad ( S34 )$$

Because of the logarithmic term, the stresses go to minus infinity as r goes to 0, so there must be a wrinkled zone (at odds with the spherical cap case, where there is no wrinkled zone at small confinement).

Using the boundary conditions σᵣᵣ(W′)=σ_{θθ}(W′)=0, σᵣᵣ(W)=γ, it is possible to arrive at an equation for x=W′/W:

$$\frac{8 γ}{{Ya}^{2}} = {x}^{2} - 1 - 2 log ( x ) . \qquad ( S35 )$$

At large confinement, one expects x=1−ε with ε=L/W<<1, and it may be found that

$$L ≃ \frac{2 W}{a} \sqrt{\frac{γ}{Y}} = \frac{2 W}{{h}^{′} W} \sqrt{\frac{γ}{Y}} , \qquad ( S36 )$$

in agreement with the general form postulated above.

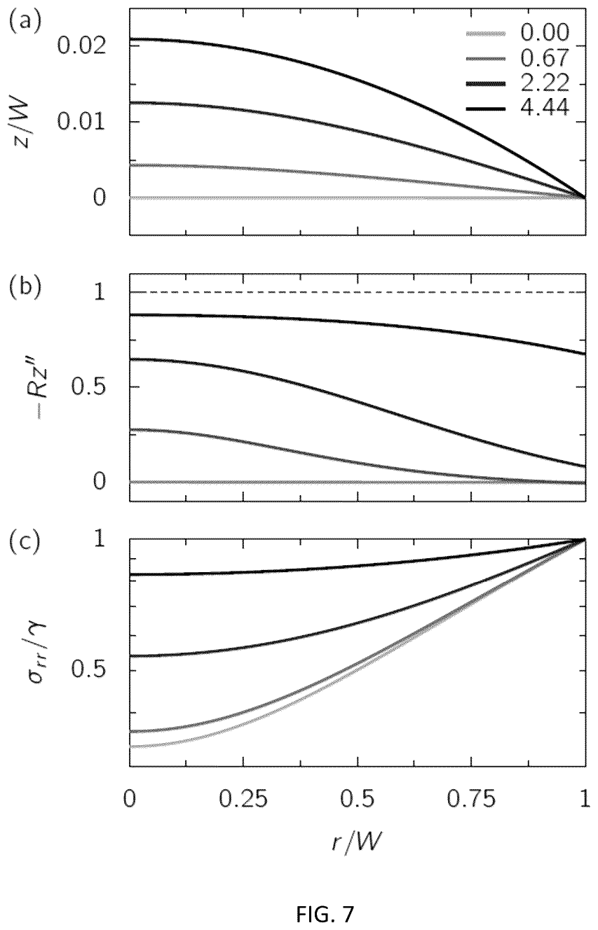

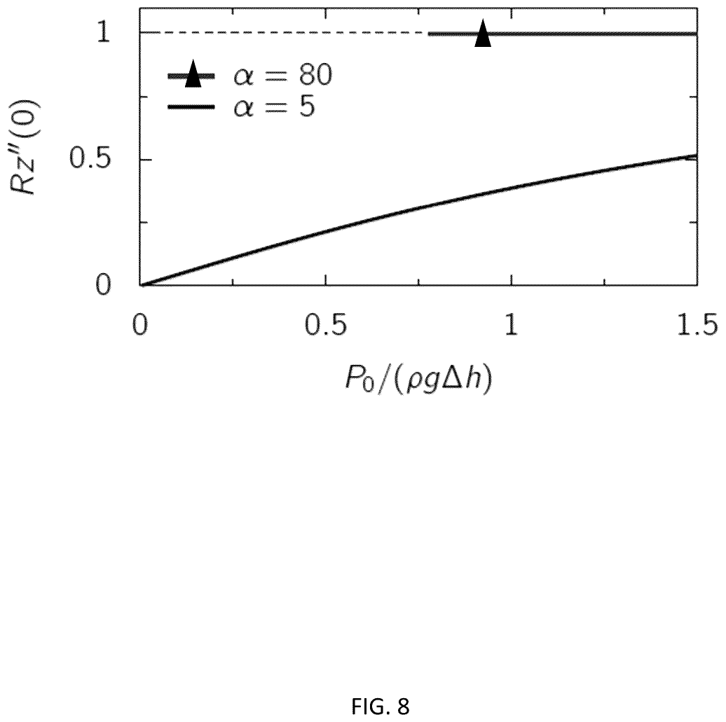

The numerical solution for a spherical shell in the low confinement regime may be described as: α=5.3<α_{c} The result, shown in FIG. 7, shows that the shape of the shell evolves continuously, and is far from the rest shape of the shell for a wide range of pressures. To highlight the difference with the large confinement regime, we plot the curvature at the center of the shell as a function of the applied pressure in the two regimes in FIG. 8. For small confinement, the curvature increases continuously from 0 (blue curve). In contrast, for large confinement, the curvature reaches the rest curvature as soon as the center inflates (red curve).

### Numerical Solution for a Conical Shell

In the numerical solution for the conical shell, for numerical and physical purposes, the tip is regularized by a sphere with radius R (the radius of the tip is thus aR)

$$h ( r ) = a \sqrt{{r}^{2} + {a}^{2} {R}^{2} .} \qquad ( S37 )$$

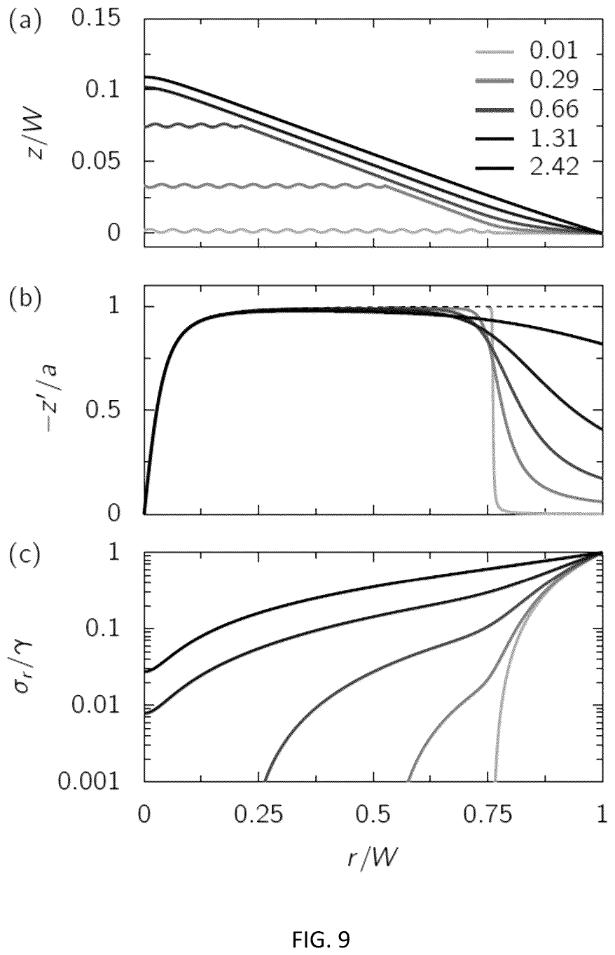

A numerical solution is shown in FIG. 9 at large confinement, α=32. The phenomenology is qualitatively identical to the spherical cap: as the pressure increases, the central wrinkled region shrinks until it disappears, while the unwrinkled region adopts the rest shape of the sheet, except in the outer rim.

What is claimed is:

1. A film for modifying at least one property of a surface of a liquid, comprising an axisymmetric shell formed from a polymer.

2. The film of claim 1, wherein the polymer is polystyrene.

3. The film of claim 1, wherein the shell has a Young's modulus of at least 3.4 gigapascal.

4. The film of claim 1, wherein the shell has a thickness of between 119 and 154 nanometers.

5. The film of claim 1, wherein the shell has a radius of curvature of between 7 and 26 millimeters.

6. The film of claim 1, wherein the shell has a boundary radius of between 1.8 and 3.1 millimeters.

7. The film of claim 1, further comprising a pressure difference across the shell.

8. A system for modifying at least one property of a surface of a liquid, comprising an axisymmetric shell formed from a polymer that is positioned on the surface of the liquid.

9. The system of claim 8, wherein the polymer is polystyrene.

10. The system of claim 8, wherein the shell has a Young's modulus of at least 3.4 gigapascal.

11. The system of claim 8, wherein the shell has a thickness of between 119 and 154 nanometers.

12. The system of claim 8, wherein the shell has a radius of curvature of between 7 and 26 millimeters.

13. The system of claim 8, wherein the shell has a boundary radius of between 1.8 and 3.1 millimeters.

14. The system of claim 8, further comprising a pressure difference across the shell.

15. The system of claim 8, further comprising an amount of oil positioned on the shell.
